(19) United States
(12) Patent Application Publication
(10) Pub. No.: US 2009/0107413 A1
(43) Pub. Date: Apr. 30, 2009

(54) Two handle vacuum cleaner for animal grooming

(76) Inventors: Assaf Shiloni, Stockton, NJ (US); Belinda L. Overman, Stockton, NJ (US)

Correspondence Address: Assaf Shiloni, 40 Britton Road, Stockton, NJ, 08559, US

(21) Appl. No.: 11/978,762

(22) Filed: Oct. 30, 2007

(51) Int. Cl. A01K 13/00

(52) U.S. Cl. 119/609

(57) ABSTRACT

A hand-held, two handle vacuum cleaner for animal grooming includes a main housing, a first handle and a second handle. The main housing has a vacuum motor for creating suction, a vacuum nozzle, an intake conduit connecting the vacuum nozzle to the vacuum motor, a trap container and filter. The hand-held vacuum cleaner has an on-off switch and a power source means, and is preferably battery operated so that it may be used in areas with no outlet access, such as horse stalls, horse shows, dog shows, etc. The first handle is located on the main housing with at least a portion of the first handle being located closer to the front than the back of the main housing. The second handle is located on the main housing behind the first handle and being located closer to the back than the front of the main housing.

### BACKGROUND OF INVENTION

a. Field of Invention

The invention relates generally to grooming of animals, and especially sports, show, competition and pet animals, such as horses, competition farm animals, zoo animals, cats, dogs and the like. More specifically, the present invention relates to hand-held, two handle vacuum cleaners for animal grooming, especially battery operated units.

b. Description of Related Art

The following patents are representative of various types of vacuum cleaners:

U.S. Pat. No. 6,481,043 B2 to Anderson et al. describes a rotary brush attachment tool for a hand-held vacuum cleaner having a dust bowl terminating in a nozzle end providing a mechanical force that acts to move foreign matter into the attachment tool from which the foreign matter is drawn into the nozzle end of the dust bowl of the hand-held vacuum cleaner to which it is removably attached.

U.S. Pat. No. 5,504,970 to Neshat et al. describes a hand-held vacuum cleaner including a housing. A nozzle is attached to and laterally offset from the housing and a bushroll is supported for rotation in the nozzle. A power drive is connected to the bushroll. A collection container is supported by the housing. A conduit external of the housing has one end detachably connected to the nozzle and another end communicating with the collection container. A vacuum source creates an airflow through the conduit to the collection container. An on-board cleaning tool is carried by the housing. The tool is removable from the housing for connection to the conduit when the one end is detached from the nozzle. The power drive includes a disconnect which stops bushroll rotation when the conduit is detached from the nozzle.

U.S. Pat. No. 5,129,128 to Bowerman et al. decribes a hand-held corded vacuum cleaner having a housing with a motor compartment containing a motor mounted on partitions defining inlet, cooling and outlet chambers for efficient motor cooling by air which enters inlet and exits outlet vents in the inlet and outlet chambers, respectively. A dirt channel extends from a fan chamber having a fan mounted by being swaged on a motor shaft. A nozzle chamber is disposed at one end of the housing and a bag assembly is removably detached from the rear of the housing by means of a collar having a side hole though which a detent extends and which may be depressed to remove the bag assembly. The nozzle is in communication with the fan chamber and the fan pushes dirt through a dirt channel over the motor compartment into the bag of the bag assembly. The motor shaft has a pulley at the end thereof which is connected to a brush which is releasably retained in the nozzle compartment. A belt extends around the brush and the pulley. A door provides access to the belt and has a post which is coaxial with the motor shaft and extends into the immediate proximity of the end thereof to prevent the belt from meandering off the shaft. A well in the belly of the housing and a cooperating well defined between projections on the handle provide a receptacle for the line cord when it is wound around the housing and handle.

U.S. Pat. No. 4,644,605 to Joss et al. describes a vacuum cleaner convertible between an upright vacuum cleaner and a portable hand carried vacuum cleaner. The conversion is accomplished by means of a handle pivotally mounted for selective movement between an open position extending from the body of the unit for manipulation thereof in an upright floor carried vacuum operation, and a closed position overlying the body of the unit wherein the handle and housing cooperate to form a handgrip of discrete length for manipulation thereof in a portable hand carried vacuum cleaning operation. The handle automatically latches upon opening and closing. The vacuum cleaner also includes a dirt reservoir and filter bag assembly carried by the body of the unit and removable from the body of the unit and separable from each other for ease of cleaning.

U.S. Pat. No. 4,225,814 to Gantz et al. describes a storing and recharging base for a cordless electric vacuum cleaner of the type which includes an elongated housing having an electric motor and fan and rechargeable batteries therein. The base has a flat bottom and key slots so that it can rest on a horizontal flat surface or be hung on a wall. The base has an upper surface contoured generally complementary to the lower surface of the vacuum cleaner housing, and has a pocket at one end which receives a nose portion of the vacuum cleaner, and a spring at the other end which releasably engages in a recess in the vacuum cleaner so that the vacuum cleaner can be stored on a horizontal surface, e.g. on a counter top or shelf, or in a drawer, or can conveniently be hung on a wall. The base also has a plug that electrically engages a receptacle in the vacuum cleaner connected to the batteries. A line cord connects the plug to a charger plug that includes a transformer and a plug for insertion into an A.C. outlet so that the batteries can be continuously recharged when the vacuum cleaner is stored on the base. The base is formed with wireways in which the line cord can be wrapped to vary the length of the line cord extending from the base.

U.S. Pat. No. 3,758,914 to Nupp et al. describes a vacuum cleaner having a handle movably carried on the body for selectively arranging the vacuum cleaner as a floor carried, upright vacuum cleaner, or a portable hand-carried vacuum cleaner. The vacuum cleaner includes a removable dirt box which underlies the handle when the vacuum cleaner is arranged as a portable hand-carried unit.

U.S. Pat. No. 3,667,084 to Valbona et al. describes a portable lightweight vacuum cleaner having an extendable nozzle intake conduit rigidly supported by an easily adjustable resilient seal losing the lower end of a filter bag compartment into which the intake conduit projects to vary the distance between a fixed operating handle and the nozzle without changing the manageability and nozzle-floor orientation with users of different statures.

U.S. Design Pat. No. 509,930 S to Stratford describes an ornamental design for a hand-held cordless vacuum cleaner, as shown and described.

U.S. Design Pat. No. 338,290 to Bart describes an ornamental design for a cordless hand-held portable vacuum cleaner, as shown and described.

United States Patent Application No. 2007/0163075 A1 to Butler et al. describes a vacuum cleaner having a generally elongated housing having a first housing end and a second housing end, a rear grip located at the first housing end, and an air inlet located at the second housing end. A vacuum fan and a motor are located within the housing and the motor is adapted to drive the vacuum fan to draw a working air flow into the air inlet. A dirt receptacle is operatively associated with the housing and adapted to remove particles from the working air flow. The vacuum cleaner also includes one or more foregrips located on the housing between the rear grip and the air inlet. In various aspects, the foregrips are adapted to: provide a user with multiple hand positions around the perimeter of the housing; simultaneously grasp the rear grip and the one or more foregrips and clean staircase surfaces while remaining substantially upright; and/or hold and operate the vacuum cleaner when the housing is rotated about its longitudinal axis at a first angular position and at a second angular position, the first angular position being approximately 90 degrees or more from the second angular position.

Notwithstanding the prior art, the present invention is neither taught nor rendered obvious thereby.

### SUMMARY OF INVENTION

The present invention is directed to a hand-held, two handle vacuum cleaner for animal grooming. It includes a main housing, a first handle and a second handle. The main housing contains and supports a vacuum motor for creating suction, a vacuum nozzle, an intake conduit connecting the vacuum nozzle to the vacuum motor, a trap container and filter located on the conduit between the vacuum nozzle and the vacuum motor, the main housing having an elongated structure with a top, a bottom, a front and a back, wherein the vacuum nozzle is proximate the front and proximate the bottom. The present invention hand-held vacuum cleaner has an on-off switch and a power source means, and is preferably battery operated so that it may be used in areas with no outlet access, such as horse stalls, horse shows, dog shows, etc. The first handle is located on the main housing with at least a portion of the first handle being located closer to the front than the back of the main housing. The second handle is located on the main housing behind the first handle and being located closer to the back than the front of the main housing.

In some preferred embodiments of the present invention hand-held, two handle vacuum cleaner for animal grooming, the vacuum nozzle has an orifice in a single plane that is located at an angle of about 70 to about 110 degrees from an imaginary centerline running from front to back of the main housing.

In some preferred embodiments of the present invention hand-held, two handle vacuum cleaner for animal grooming, at least one of the first handle and the second handle is a knob handle. In other preferred embodiments, at least one of the first handle and the second handle is an open loop handle. In other preferred embodiments, at least one of the first handle and the second handle is a bar handle. In other preferred embodiments, at least one of the first handle and the second handle is an open loop handle and the other of the first handle and the second handle is a bar handle. In other preferred embodiments, at least one of the first handle and the second handle is a knob handle and the other of the first handle and the second handle is a bar handle. In other preferred embodiments, at least one of the first handle and the second handle is an open loop handle and the other of the first handle and the second handle is a knob handle.

In some preferred embodiments of the present invention hand-held, two handle vacuum cleaner for animal grooming, the first handle and the second handle are the same type of handle, the type of hand being selected from the group consisting of bar handles, knob handles and open loop handles.

In some preferred embodiments of the present invention hand-held, two handle vacuum cleaner for animal grooming, the first handle and the second handle are in alignment with one another, while in others they are not in alignment with one another. For example, one handle may be vertically positioned when in use while the other may be a non-vertical protrusion.

In some preferred embodiments of the present invention hand-held, two handle vacuum cleaner for animal grooming, the vacuum motor is connected to a power source means selected from the group consisting of rechargeable battery, disposable battery, fuel cell, AC connector and DC connector.

In some preferred embodiments of the present invention hand-held, two handle vacuum cleaner for animal grooming, the vacuum nozzle includes at least one component selected from the group consisting of a brush and a comb.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a side perspective view of an embodiment of a present invention hand-held, two handle vacuum cleaner for animal grooming;

FIG. 2 is a side view of the embodiment of the present invention hand-held, two handle vacuum cleaner for animal grooming shown in FIG. 1;

FIG. 3 is a cut side view of the embodiment of the present invention hand-held, two handle vacuum cleaner for animal grooming shown in FIG. 1, illustrating the internal functional mechanisms;

FIG. 4 is a side view of another embodiment of a present invention hand-held, two handle vacuum cleaner for animal grooming, illustrating a bar handle and a knob handle;

FIG. 5 is a side view of another embodiment of a present invention hand-held, two handle vacuum cleaner for animal grooming, illustrating dual open loop handles;

FIG. 6 is a side view of another embodiment of a present invention hand-held, two handle vacuum cleaner for animal grooming, illustrating dual knob handles; and,

FIG. 7 is a side view of another embodiment of a present invention hand-held, two handle vacuum cleaner for animal grooming, illustrating dual bar handles.

### DETAILED DESCRIPTION OF THE EMBODIMENTS

Referring now in detail to the drawings wherein like reference numerals designate corresponding parts throughout the several views, various embodiments of the present invention are shown.

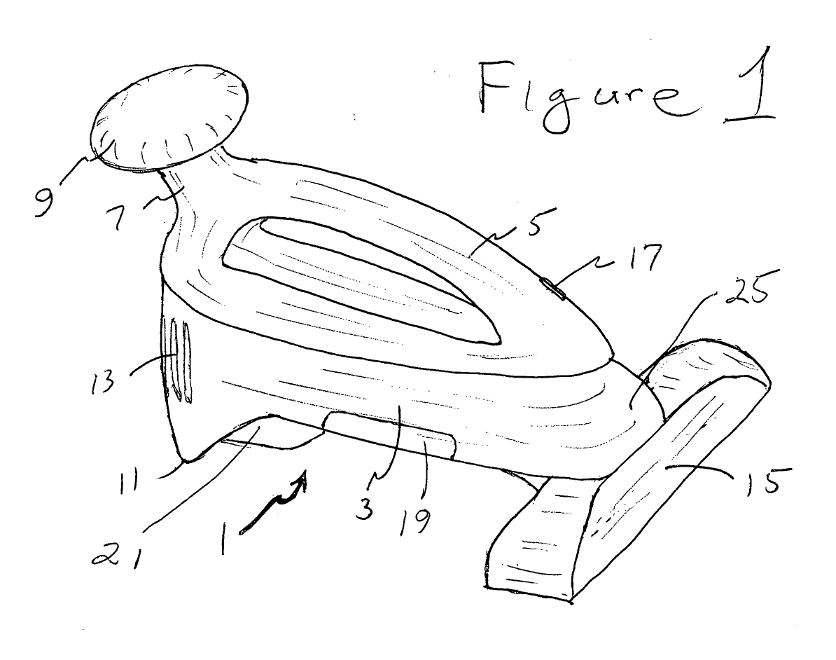

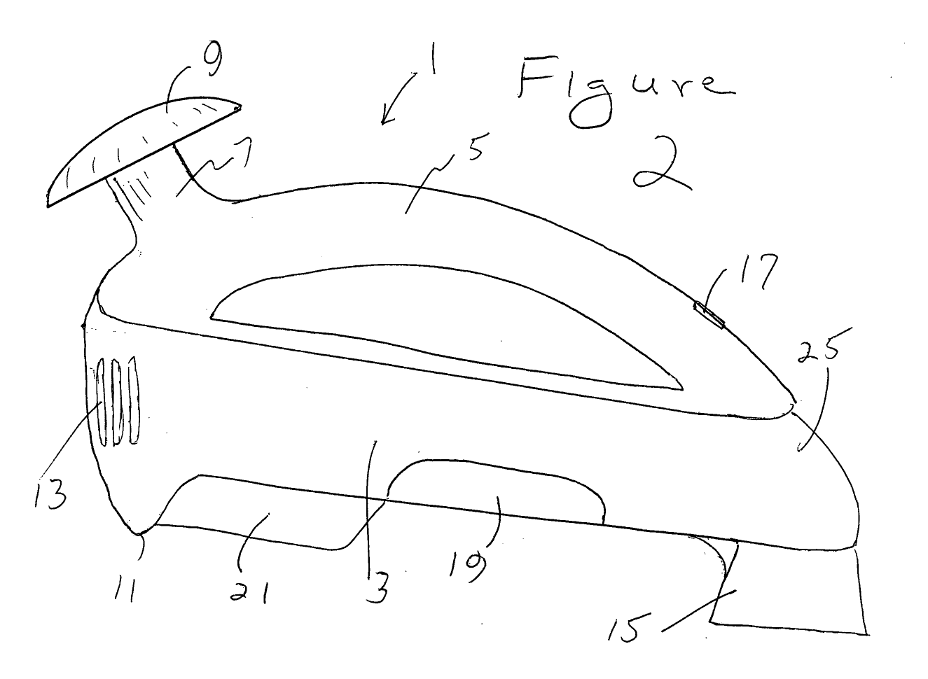

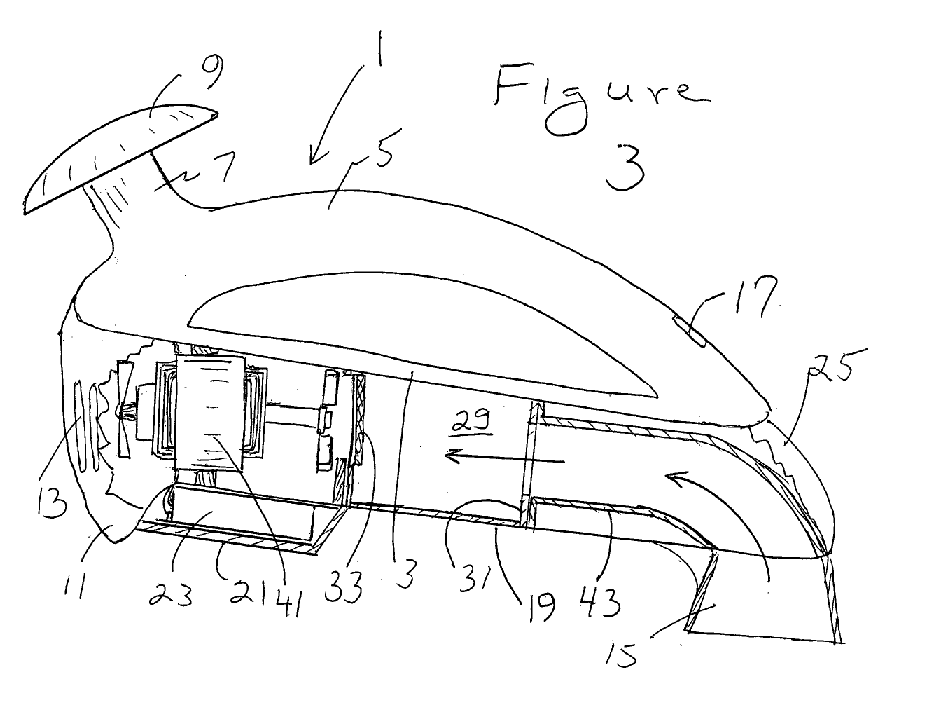

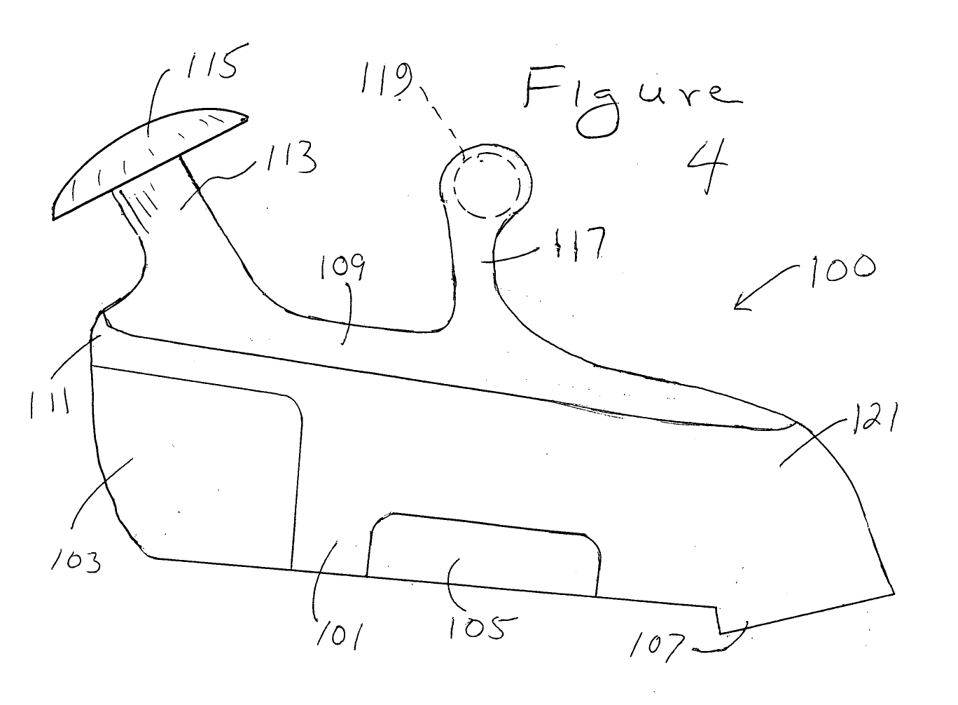

FIG. 1 is a side perspective view of an embodiment of a present invention hand-held, two handle vacuum cleaner 1, FIG. 2 is a side view of the embodiment of the present invention hand-held, two handle vacuum cleaner 1 shown in FIG. 1 and FIG. 3 is a cut side view of the embodiment of the present invention hand-held, two handle vacuum cleaner 1 shown in FIGS. 1 and 2, illustrating the internal functional mechanisms. These three Figures are discussed collectively with the understanding that not all reference numerals are in all Figures.

Present invention vacuum cleaner 1 has a main housing 3 made of plastic or other appropriate material or materials that contains the vacuum functional features internally, and the critical operational functional features externally. Hence, there are two handles on vacuum cleaner 1, namely, first handle 5 and second handle 9, first handle 5 being a front handle that is an open loop handle, and second handle 9, connected to stem 7, being a back handle that is a knob handle. The vacuum cleaner 1 is elongated from front 25 to back 11 and has a vacuum nozzle 15 located at its front 25. There is a control on-off switch 17. There is also a removable trap container cover 19 for cleaning and disposing of the vacuumed debris, as well as a removable power pack cover 21, for replacing power source 23.

Internally, there is a vacuum conduit 43 that extends from nozzle 15 to vacuum motor Vacuum motor cooling vents 13 are in the back area near the motor 41. Between motor 41 and nozzle 15 on conduit 43 is a trap container 31 with filter 33 that entraps vacuumed debris in space 29. Cover 19 and container are integrally formed so that a user pulls on cover 19 and inherently removes trap container 31 with filter 33 for disposal of the contents and sometimes cleaning or replacement of the filter. Nozzle 15 is shown in this embodiment as a wide, rectangular nozzle, but in any present invention embodiment, it could be a round or square or other shaped nozzle. The user holds the vacuum cleaner 1 with both hands to simultaneously groom and vacuum clean the animal, typically with consistent unidirectional strokes.

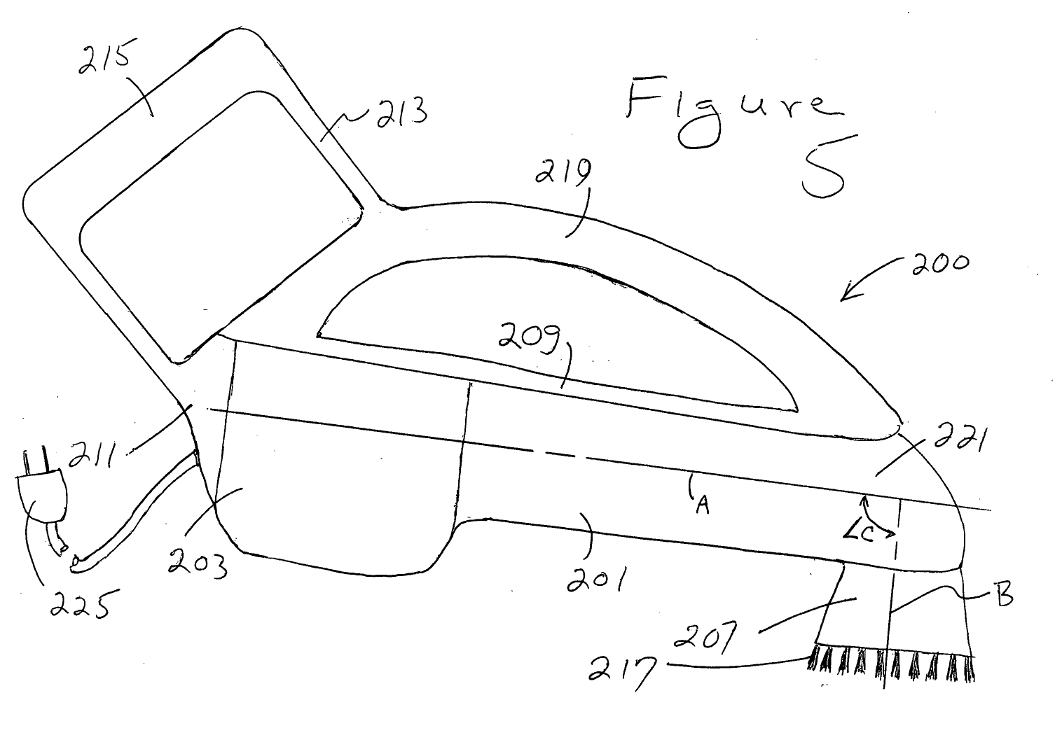

FIG. 4 is a side view of another embodiment of a present invention hand-held, two handle vacuum cleaner 100 for animal grooming. It is similar to the present invention vacuum cleaner 1 in the preceding Figures, except that, externally, the handle arrangement is different and, internally, the motor and trap container are juxtapositioned so that a conduit (not shown) runs from the nozzle 107 at the front 121 of main housing 101, to the trap container at back 111 and then to a center positioned motor located above the power pack cover 105. As mentioned, there are two handles on vacuum cleaner 100 located on top 109, namely, first handle 119 and second handle 115, first handle 119 being a front handle that is a bar handle supported by two uprights, such as upright 117, and second handle 115, connected to stem 113, being a back handle that is a knob handle. The vacuum cleaner 100 is elongated from front 121 to back 111 and has a vacuum nozzle 107 located at its front 121. There is a control on-off switch (not shown). There is also a removable trap container rear cover 103 for cleaning and disposing of the vacuumed debris, as well as a removable power pack cover 105, for replacing a power source when necessary.

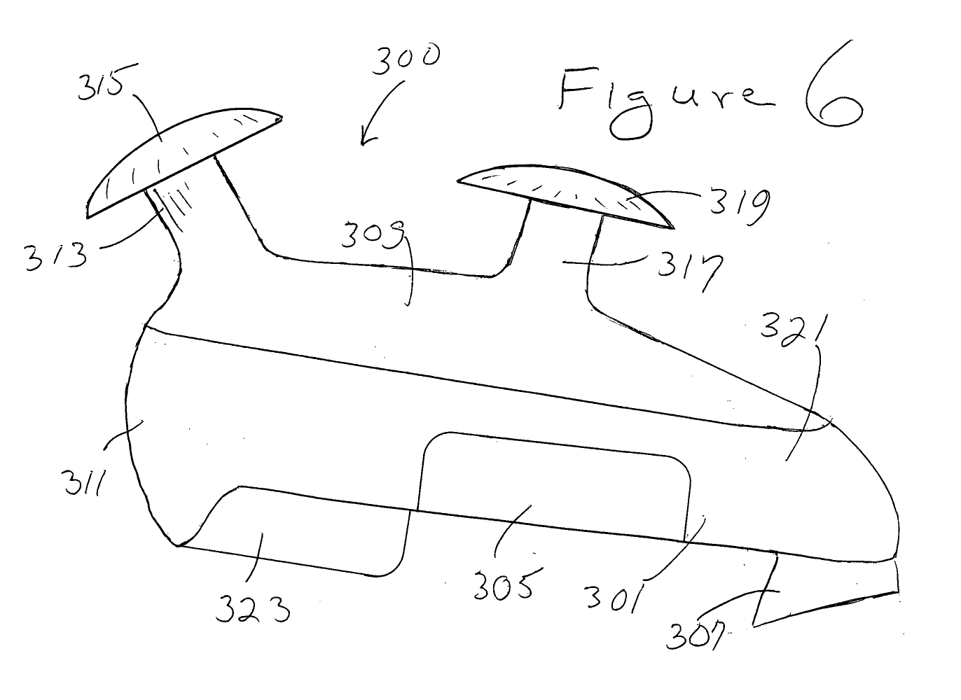

FIG. 5 is a side view of another embodiment of a present invention hand-held, two handle vacuum cleaner 200 for animal grooming, illustrating dual loop handles. The two handles on vacuum cleaner 200 are first open loop handle 219 and second open loop handle 215, first handle 219 being a front and second handle 215 being a back handle. The vacuum cleaner 200 has a main housing 201 with front 221 and a back 211 and has a vacuum nozzle 207 located at its front 221. There is a control on-off switch, not shown. There is also a removable trap container cover 203 for cleaning and disposing of the vacuumed debris, as well as power source means, namely, cord and plug 225, for AC or DC power. Nozzle 207 has a brush 217 that is a useful option in grooming.

In FIG. 5, there is shown an imaginary centerline A along the main housing of the vacuum cleaner 200 from front to back. Nozzle 207 has an imaginary flow path centerline B and has an orifice in a single plane that is located at an angle C. In some preferred embodiments, angle C is about 70 to about 110 degrees.

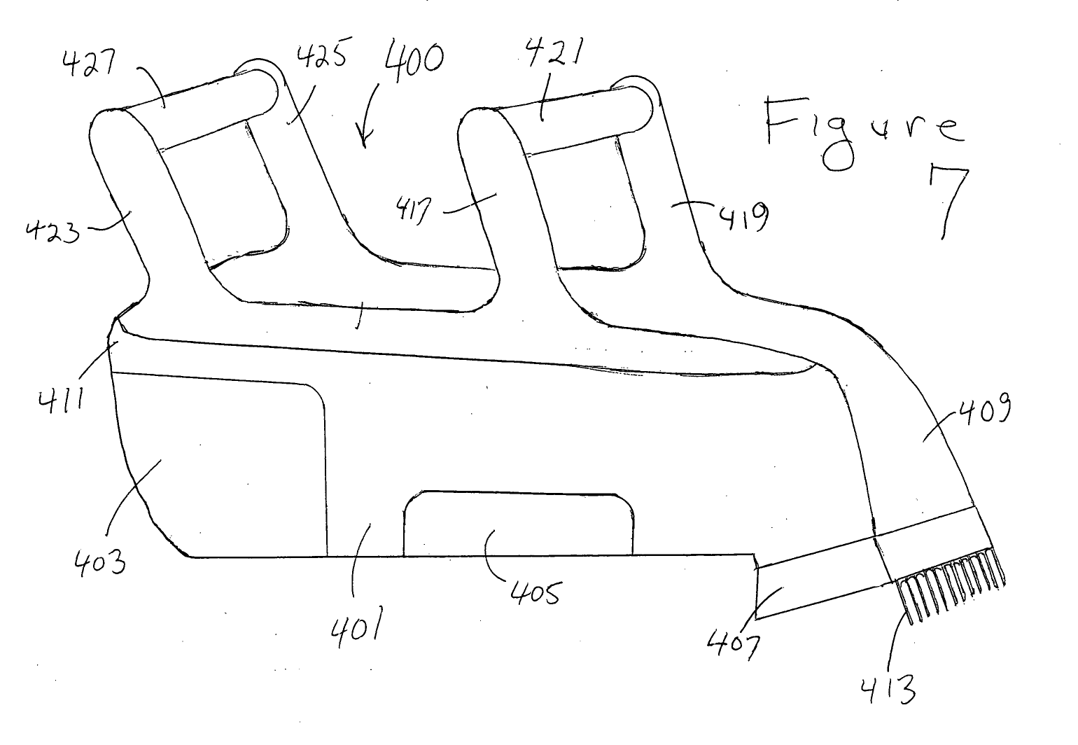

FIG. 6 is a side view of another embodiment of a present invention hand-held, two handle vacuum cleaner 300 for animal grooming. It is similar in many aspects to the present invention vacuum cleaner 1 in the preceding Figures, except that motor vents are not shown, and, externally, the handle arrangement is different. The two handles on vacuum cleaner 300 are located on top 309 of main housing 301. Both first handle 319 on stem 317 and second handle 315 on stem 313 are knob handles. The vacuum cleaner 300 is elongated from front 321 to back 311 and has a vacuum nozzle 307 located at its front 321. There is a control on-off switch (not shown). There is also a removable trap container cover 305 for cleaning and disposing of the vacuumed debris, as well as a removable power pack cover 323, for replacing a power pack source when necessary.

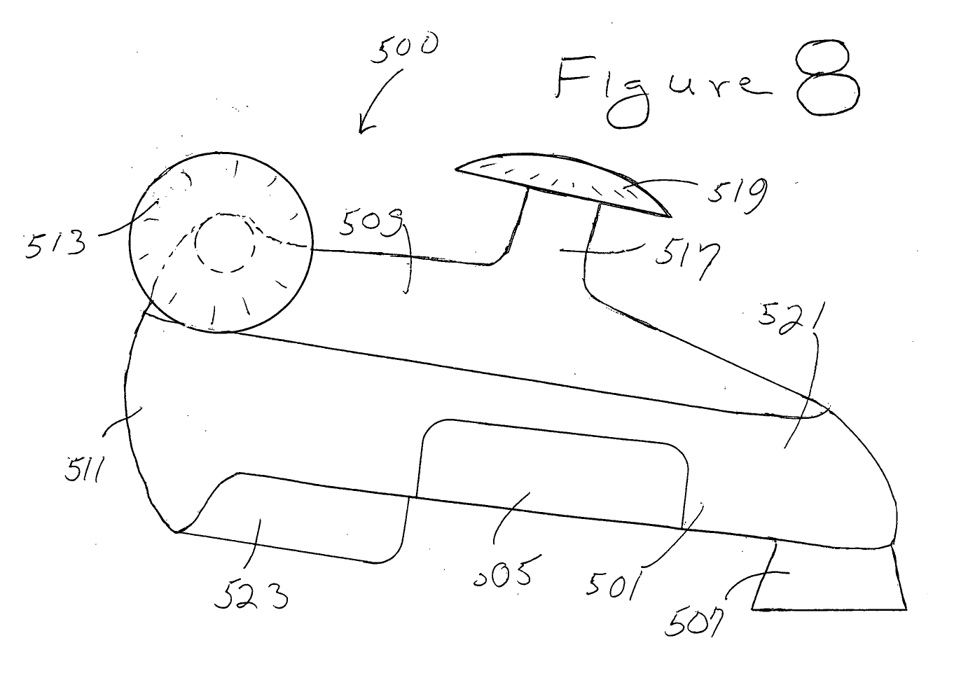

FIG. 7 is a side view of another embodiment of a present invention hand-held, two handle vacuum cleaner 400 for animal grooming. It is similar in many aspects to the present invention vacuum cleaner 100 in FIG. 4, except that the handle arrangement is different. The two handles on vacuum cleaner 400 are located on top of main housing 401. Both first handle 421 on uprights 417 and 419 and second handle 427 on uprights 423 and 425 are supported bar handles. The vacuum cleaner 400 is elongated from front 421 to back 411 and has a vacuum nozzle 407 with a front comb 413, located at its front 421. There is a control on-off switch (not shown). There is also a removable trap container cover 403 for cleaning and disposing of the vacuumed debris, as well as a removable power pack cover 405, for replacing a power pack source when necessary.

FIG. 8 is a side view of another embodiment of a present invention hand-held, two handle vacuum cleaner 500 for animal grooming. It is similar in many aspects to the present invention vacuum cleaner 300 in FIG. 6, except that the handle arrangement is different. The two handles on vacuum cleaner 500 are located on top 509 of main housing 401, but the handles being approximately at right angles to one another. Both first handle 519 on stem 517 and second handle 513 on a hidden stem are knob handles. First handle 519 is in a vertical extension when in use while second handle 513 is in a horizontal extension when in use. Other angles could be used without exceeding the scope of the present invention. Further, handle 513 could be excluded and the hidden stem could be an extended bar handle. The vacuum cleaner 00 is elongated from front 521 to back 511 and has a vacuum nozzle 507 located at its front 521. There is a control on-off switch (not shown). There is also a removable trap container cover 505 for cleaning and disposing of the vacuumed debris, as well as a removable power pack cover 503, for replacing a power pack source when necessary.

All of the devices herein may be used as described in conjunction with present invention vacuum cleaner 1 above.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A hand-held, two handle vacuum cleaner for animal grooming, comprising:
a) a main housing containing a vacuum motor for creating suction, a vacuum nozzle, an intake conduit connecting the vacuum nozzle to the vacuum motor, a trap container and filter located on said conduit between said vacuum nozzle and said vacuum motor, said main housing having an elongated structure with a top, a bottom, a front and a back, wherein said vacuum nozzle is proximate said front and proximate said bottom;
b) a first handle located on said main housing with at least a portion of said first handle being located closer to said front than said back of said main housing; and,
c) a second handle located on said main housing behind said first handle and being located closer to said back than said front of said main housing.

2. The hand-held, two handle vacuum cleaner for animal grooming of claim 1 wherein said vacuum nozzle has an orifice in a single plane that is located at an angle of about 70 to about 110 degrees from an imaginary centerline running from front to back of said main housing.

3. The hand-held, two handle vacuum cleaner for animal grooming of claim 1 wherein at least one of said first handle and said second handle is a knob handle.

4. The hand-held, two handle vacuum cleaner for animal grooming of claim 1 wherein at least one of said first handle and said second handle is an open loop handle.

5. The hand-held, two handle vacuum cleaner for animal grooming of claim 1 wherein at least one of said first handle and said second handle is a bar handle.

6. The hand-held, two handle vacuum cleaner for animal grooming of claim 1 wherein at least one of said first handle and said second handle is an open loop handle and the other of said first handle and said second handle is a bar handle.

7. The hand-held, two handle vacuum cleaner for animal grooming of claim 1 wherein at least one of said first handle and said second handle is a knob handle and the other of said first handle and said second handle is a bar handle.

8. The hand-held, two handle vacuum cleaner for animal grooming of claim 1 wherein at least one of said first handle and said second handle is an open loop handle and the other of said first handle and said second handle is a knob handle.

9. The hand-held, two handle vacuum cleaner for animal grooming of claim 1 wherein said first handle and said second handle are the same type of handle, said type of hand being selected from the group consisting of bar handles, knob handles and open loop handles.

10. The hand-held, two handle vacuum cleaner for animal grooming of claim 1 wherein said vacuum motor is connected to a power source means selected from the group consisting of rechargeable battery, disposable battery, fuel cell, AC connector and DC connector.

11. A hand-held, two handle vacuum cleaner for animal grooming, comprising:
a) a main housing containing a vacuum motor for creating suction, a vacuum nozzle, an intake conduit connecting said vacuum nozzle to said vacuum motor, a trap container and filter located on said conduit between said vacuum nozzle and said vacuum motor, said main housing having an elongated structure with a top, a bottom, a front and a back, wherein said vacuum nozzle is proximate said front and proximate said bottom and wherein said nozzle includes at least one component selected from the group consisting of a brush and a comb;
b) a first handle located on said main housing with at least a portion of said first handle being located closer to said front than said back of said main housing; and,
c) a second handle located on said main housing behind said first handle and being located closer to said back than said front of said main housing.

12. The hand-held, two handle vacuum cleaner for animal grooming of claim 11 wherein said vacuum nozzle has an orifice in a single plane that is located at an angle of about 70 to about 110 degrees from an imaginary centerline running from front to back of said main housing.

13. The hand-held, two handle vacuum cleaner for animal grooming of claim 11 wherein at least one of said first handle and said second handle is a knob handle.

14. The hand-held, two handle vacuum cleaner for animal grooming of claim 11 wherein at least one of said first handle and said second handle is an open loop handle.

15. The hand-held, two handle vacuum cleaner for animal grooming of claim 11 wherein at least one of said first handle and said second handle is a bar handle.

16. The hand-held, two handle vacuum cleaner for animal grooming of claim 11 wherein at least one of said first handle and said second handle is an open loop handle and the other of said first handle and said second handle is a bar handle.

17. The hand-held, two handle vacuum cleaner for animal grooming of claim 11 wherein at least one of said first handle and said second handle is a knob handle and the other of said first handle and said second handle is a bar handle.

18. The hand-held, two handle vacuum cleaner for animal grooming of claim 11 wherein at least one of said first handle and said second handle is an open loop handle and the other of said first handle and said second handle is a knob handle.

19. The hand-held, two handle vacuum cleaner for animal grooming of claim 11 wherein said first handle and said second handle are the same type of handle, said type of hand being selected from the group consisting of bar handles, knob handles and open loop handles.

20. The hand-held, two handle vacuum cleaner for animal grooming of claim 11 wherein said vacuum motor is connected to a power source means selected from the group consisting of rechargeable battery, disposable battery, fuel cell, AC connector and DC connector.
